(19) United States
(12) Patent Application Publication
(10) Pub. No.: US 2023/0021813 A1
(43) Pub. Date: Jan. 26, 2023

(54) DATA PRODUCT GENERATION AND PRODUCTION BASED ON RESEGMENTING AND/OR MERGING ROAD SEGMENTS

(71) Applicant: Wejo Limited, Manchester (GB)

(72) Inventors: Roger Downing, Chester (GB); Stephen Millington, St. Helens (GB); Matthew Slack, Manchester (GB)

(21) Appl. No.: 17/381,559

(22) Filed: Jul. 21, 2021

(51) Int. Cl. G08G 1/01; G08G 1/09

(52) U.S. Cl. CPC G08G 1/0145; G08G 1/0108; G08G 1/091

(57) ABSTRACT

A system configured to, and method of, generating and providing a data product using data supplied by a multitude of vehicles. The system/method includes carrying out a re-segmentation process in which an initial set of road segments are processed so as to obtain a re-segmented set of road segments; attributing traffic data to at least a subset of the re-segmented set of road segments, wherein, for each road segment of the subset of road segments, a portion of the traffic data is attributed to the road segment based on geographical proximity; carrying out a road segment merging process on the re-segmented set of road segments in order to obtain a merged set of road segments; aggregating metrics associated with the merged set of road segments to obtain aggregated road segment data; generating the data product using the aggregated road segment data; and providing the data product to a third party.

### TECHNICAL FIELD

This invention relates to methods and systems for processing large volumes of geospatial road data in order to reduce the size of the data while maintaining a sufficient level of detail, and for then generating and producing a data product based thereon.

### BACKGROUND

Nowadays, large amounts of data are streamed from automobiles and other vehicles, and this data is used for various purposes, such as for providing traffic conditions of roads. Some vehicle data, such as its geographical position or location, is included in these vehicle data streams that are transmitted to a remote system, which may then store the data and/or package the data into a data product. The vehicle data is matched to a predefined road segment based on its geographical proximity to the predefined road segment and, oftentimes, further based on the vehicle's heading. The predefined road segments that the geographical locations are matched with may be used for myriad applications and may not be defined in a way that is specifically tailored for use with vehicle traffic or other information.

### SUMMARY

According to one aspect of the invention, there is provided a data product system for generating and providing a data product using data supplied by a multitude of vehicles, wherein the data product system comprises one or more electronic processors and memory storing computer instructions accessible by the one or more electronic processors of the data product system; wherein the data product system is configured so that, when the computer instructions are executed by the one or more electronic processors of the data product system, the data product system: carries out a re-segmentation process in which an initial set of road segments are processed so as to obtain a re-segmented set of road segments, wherein the re-segmented set of road segments includes a first re-segmented road segment and a second re-segmented road segment, and wherein the first re-segmented road segment and the second re-segmented road segment are obtained by splitting a road segment of the initial set of road segments; attributes traffic data to at least a subset of the re-segmented set of road segments, wherein, for each road segment of the subset of re-segmented road segments, a portion of the traffic data is attributed to the road segment based on a geographical proximity of the road segment to the portion of traffic data; carries out a road segment merging process on the re-segmented set of road segments in order to obtain a merged set of road segments; aggregates metrics associated with the merged set of road segments to obtain aggregated road segment data; generates the data product using the aggregated road segment data; and provides the data product to a third party.

According to various embodiments, the data product system may further include any one of the following features or any technically-feasible combination of some or all of the features:
the merged set of road segments includes a merged road segment, and wherein the merged road segment is a concatenation of the first re-segmented road segment and a third re-segmented road segment of the re-segmented set of road segments;
the road segment merging process includes determining whether to merge two re-segmented road segments of the re-segmented set of road segments based on a correlation of vehicle travel between the two re-segmented road segments;
the correlation of vehicle travel is determined using a cosine similarity technique;
as a part of the road segment merging process, it is determined to merge the two re-segmented road segments when the correlation of vehicle travel is above a predetermined threshold amount;
the re-segmentation process includes identifying a shared node, wherein the shared node is a part of a first initial road segment of the initial set of road segments and a second initial road segment of the initial set of road segments, and wherein the shared node is not an end node of the first initial road segment or the second initial road segment;
the initial set of road segments are obtained from a third party system;
the third party system is OpenStreetMap™;
the traffic data is or is based on geographical location data streams from at least a subset of the multitude of vehicles;
the metrics associated with the merged set of road segments includes traffic-related metrics, and wherein the traffic-related metrics are based on the attributed traffic data;
the traffic-related metrics include an amount or indication of traffic congestion for a given road segment of the merged set of road segments; and/or
the aggregated road segment data includes an average vehicle speed for a given road segment of the merged set of road segments.

According to another aspect of the invention, there is provided a method of generating and providing a data product using data supplied by a multitude of vehicles, wherein the method is carried out by a data product system comprising one or more electronic processor. The method includes: carrying out a re-segmentation process in which an initial set of road segments are processed so as to obtain a re-segmented set of road segments, wherein the re-segmented set of road segments includes a first re-segmented road segment and a second re-segmented road segment, and wherein the first re-segmented road segment and the second re-segmented road segment are obtained by splitting a road segment of the initial set of road segments; attributing traffic data to at least a subset of the re-segmented set of road segments, wherein, for each road segment of the subset of re-segmented road segments, a portion of the traffic data is attributed to the road segment based on a geographical proximity of the road segment to the portion of traffic data; carrying out a road segment merging process on the re-segmented set of road segments in order to obtain a merged set of road segments; aggregating metrics associated with the merged set of road segments to obtain aggregated road segment data; generating the data product using the aggregated road segment data; and providing the data product to a third party.

According to various embodiments, the method may further include any one of the following features or any technically-feasible combination of some or all of the features:
the merged set of road segments includes a merged road segment, and wherein the merged road segment is a concatenation of the first re-segmented road segment and a third re-segmented road segment of the re-segmented set of road segments;
the road segment merging process includes determining whether to merge two re-segmented road segments of the re-segmented set of road segments based on a correlation of vehicle travel between the two re-segmented road segments;
the correlation of vehicle travel is determined using a cosine similarity technique;
as a part of the road segment merging process, it is determined to merge the two re-segmented road segments when the correlation of vehicle travel is above a predetermined threshold amount;
the re-segmentation process includes identifying a shared node, wherein the shared node is a part of a first initial road segment of the initial set of road segments and a second initial road segment of the initial set of road segments, and wherein the shared node is not an end node of the first initial road segment or the second initial road segment;
the initial set of road segments are obtained from a third party system;
the third party system is OpenStreetMap™;
the traffic data is or is based on geographical location data streams from at least a subset of the multitude of vehicles;
the metrics associated with the merged set of road segments includes traffic-related metrics, and wherein the traffic-related metrics are based on the attributed traffic data;
the traffic-related metrics include an amount or indication of traffic congestion for a given road segment of the merged set of road segments; and/or
the aggregated road segment data includes an average vehicle speed for a given road segment of the merged set of road segments.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications system that includes a data product system and a plurality of vehicles, according to one embodiment;

FIG. 2 depicts a block diagram illustrating components of the communications system of FIG. 1, according to one embodiment;

FIG. 3 is a flowchart of a method of generating and providing a data product using data supplied by a multitude of vehicles, according to one embodiment;

FIG. 4 is a diagram of three road segments where two of the road segments overlap;

FIG. 5 is a diagram of re-segmented road segments that are generated as a result of a re-segmentation process that is carried out on the road segments of FIG. 4;

FIG. 6 is a diagrammatic overhead view of roadways and associated road segments of those roadways;

FIG. 7 is a diagram depicting the road segments of FIG. 6, including their connections to one another;

FIG. 8 is a directed graph illustrating traffic correlations between adjacent or conjoining ones of the road segments of FIG. 6;

FIG. 9 is a directed graph illustrating groups of the road segments of FIG. 6, where the road segments of each group are to be merged together to form a single, merged road segment as a result of a road segment merging process; and

FIG. 10 is a diagram depicting the road segments of FIG. 6 as merged according to the road segment merging process.

### DETAILED DESCRIPTION

The data product system and method described herein enables generating and providing a data product based on data collected from a multitude of vehicles, such as traffic data and/or other aggregated vehicle metrics (e.g., average vehicle speed). The traffic data may be obtained from data streams that are transmitted by the multitude of vehicles and associated with a road segment, which is defined as a collection (i.e., two or more) of geographical points or nodes, which may each be specified by a latitudinal-longitudinal coordinate pair. The road segments may be defined by a third party, such as OpenStreetMap™. It has been discovered that, at least in some instances, certain road segments are defined in a way such that two or more road segments intersect each other. Vehicle data, which may be received from a vehicle data stream from a connected vehicle, is matched with road segments based on geographical proximity and, in some embodiments, an overall or aggregate value for a matched road segment may be determined based on aggregating the vehicle data, such as to determine an average linear vehicle speed that the vehicle traveled at when traversing the portion of the road corresponding to the matched road segment. When aggregating or combining such metrics or values for multiple road segments, it may be difficult to obtain accurate values due to the imposition of such intersecting road segments, especially in instances where a vehicle only travels for a portion of a road segment. Therefore, in accordance with at least some embodiments, a re-segmentation process may be carried out on an initial set of road segments (e.g., those received from a third party) so that the resulting set of road segments (i.e., the re-segmented set of road segments) does not include road segments that intersect each other, but, rather, the road segments of the initial set that did intersect each other are split at the point(s) of intersection. The traffic data or other vehicle data may then be associated with the re-segmented set of road segments obtained from the re-segmentation process, which allows the aggregation of traffic and/or other vehicle-related data to be carried out in an accurate and concise manner.

Additionally, it has been discovered that, in at least some instances, the initial set of road segments may be unnecessarily restricted to being a predefined distance (e.g., 200 m in the case of OpenStreetMap™). Thus, at least in some instances, it may be desirable to merge one or more road segments so as to obtain a merged road segment set in which certain road segments are merged. This allows the amount of resulting road segments (and, thus, data) to be reduced and enables more efficient processing while still maintaining a high level of precision in the traffic data and/or other vehicle metrics/data. According to at least some embodiments, the system may be used to carry out a method that includes: carrying out a re-segmentation process; matching the traffic data (and/or other vehicle data) to the re-segmented set of road segments; carrying out a road segment merging process on the re-segmented set of road segments to obtain a merged set of road segments; and aggregating the matched traffic data and/or other vehicle data/metrics based on the merged set of segments. This enables the traffic data and/or other vehicle data to be accurately aggregated while, at the same time, reduces the size of the data representing such metrics thereby resulting in an improvement to large-scale computer data processing, real-time computer data processing, and/or large-scale, real-time computer data processing, at least according to some embodiments. In some instances, for example when using OpenStreetMap™ ways as the initial set of road segments, the United States may be represented by 100 million ways or road segments. In at least one instance, and according to one embodiment, it has been discovered that the re-segmentation process, as carried out on the 100 million initial road segments, results in 110 million re-segmented road segments. However, by subsequently carrying out a road segment merging process on the 110 million re-segmented road segments, the size of the resulting merged set of road segments is much smaller than the size of the re-segmented set of road segments.

As used herein, a “real-time” data product is a data product that is continuously generated and transmitted out to one or more customers as data is received by the product data system. The length of time during which this continuous process occurs may vary depending on the needs of the customer and/or based on other factors. This length of time could be minutes or hours or days at a time. In some embodiments, real-time may refer to the use of “live data” which is defined herein as data for which the mean total time taken by a plurality (two or more) or multitude (1,000 or more) of sequential location data points to be transmitted from the vehicle, received at the data product system, and incorporated into (or obfuscated/rejected from) the real-time data product is equal to 120 seconds or less. In some embodiments, the processing carried out at the data product system may be done instantaneously or near-instantaneously, where “instantaneous” means the mean is less than twenty seconds and “near-instantaneous” means the mean is less than forty-five seconds. The instantaneous and near-instantaneous processing may be considered to occur in real-time.

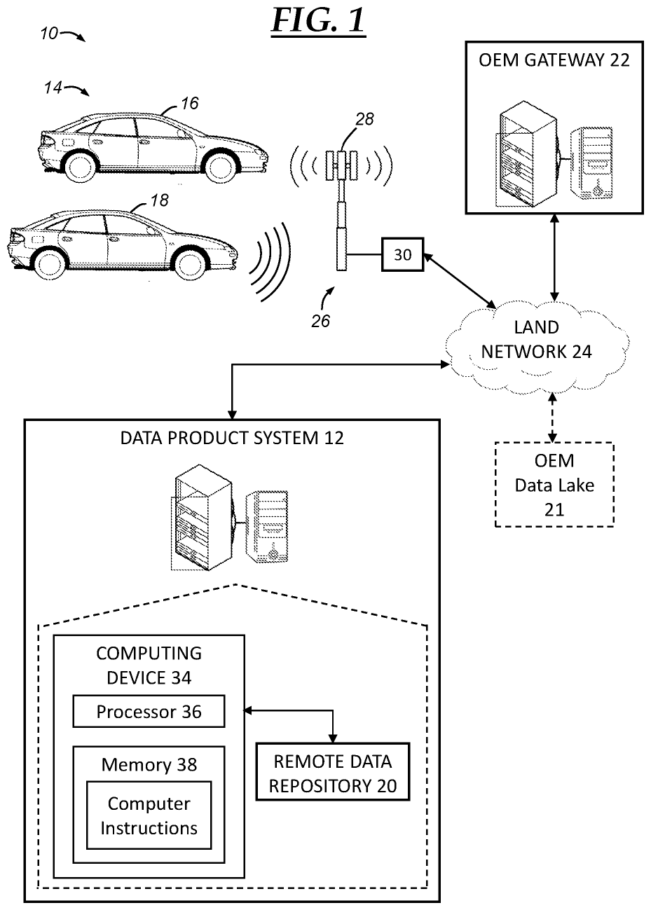

With reference now to FIG. 1, there is shown a communications system 10 that includes a data product system 12, a plurality of vehicles 14 including a first vehicle 16 and a second vehicle 18, an OEM data repository or data lake 21, an OEM gateway 22, a land network 24, and a wireless carrier system 26. Although only two vehicles are shown, it will be appreciated that the system is intended to be capable of working with a multitude of vehicles 14 (i.e., at least 1,000 vehicles) and even with millions of vehicles 14. Also, as used herein, the “vehicles” with which the data product system is used are connected vehicles (CVs) that are capable of wireless communication of data from the vehicle to a data lake or other remote data repository. It should be appreciated that while the illustrated embodiment of FIG. 1 provides an example of one such communications system 10, the data product system 12 and method(s) described below may be used as a part of various other communications systems.

The land network 24 may be a conventional land-based telecommunications network that is connected to one or more landline telephones and connects the wireless carrier system 26 to the data product system 12, the OEM data lake 21, and the OEM gateway 22. For example, the land network 24 may include a public switched telephone network (PSTN) such as that used to provide hardwired telephony, packet-switched data communications, and the Internet infrastructure. One or more segments of the land network 24 could be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 26 may be any suitable cellular telephone system. The wireless carrier system 26 is shown as including a cellular tower 28; however, the wireless carrier system 26 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components used to connect the wireless carrier system 26 with the land network 24 or to connect the wireless carrier system 26 with user equipment (UEs, e.g., which may include telematics equipment in the vehicles 14), all of which is indicated generally at 30. The wireless carrier system 26 may implement any suitable communications technology, including, for example, 5G, GSM/GPRS technology, CDMA or CDMA2000 technology, LTE technology, etc. In general, the wireless carrier system 26, its components, the arrangement of its components, the interaction between the components, etc. is generally known in the art.

The remote data repository 20 is used to store data received from the vehicles 14. For example, the vehicles 14 may each be configured to transmit data, which may be a part of a data stream, to the remote data repository 20 via the wireless carrier system 26 and the land network 26. The remote data repository 20, upon receiving the data, may store the data. The remote data repository 20 is shown as a part of the data product system 12, which may be owned and operated by an independent commercial partner of one or more of the vehicle original equipment manufacturers (OEMs). In other embodiments, the remote data repository 20 may be any publicly or privately accessible aggregation of stored data, which can be structured or unstructured data and which is accessible over a global communications network such as the internet. For example, as optionally shown in FIG. 1, the OEM may have its own data lake (repository) 21 to which the data from the vehicles are initially stored and then accessed (e.g., in real-time) by the data product system 12 to generate the data product(s). However implemented, the remote data repository 20 is remote in the sense that it is remote from the vehicles 14, but in some embodiments may be co-located with the data product system 12 (as shown) and/or with the OEM gateway 22. The remote data repository 20 may be, for example, one or more databases, data lakes, data warehouses, or some combination thereof. The OEM data lake 21 is also considered a remote data repository in the sense that it is remote from the vehicles 14.

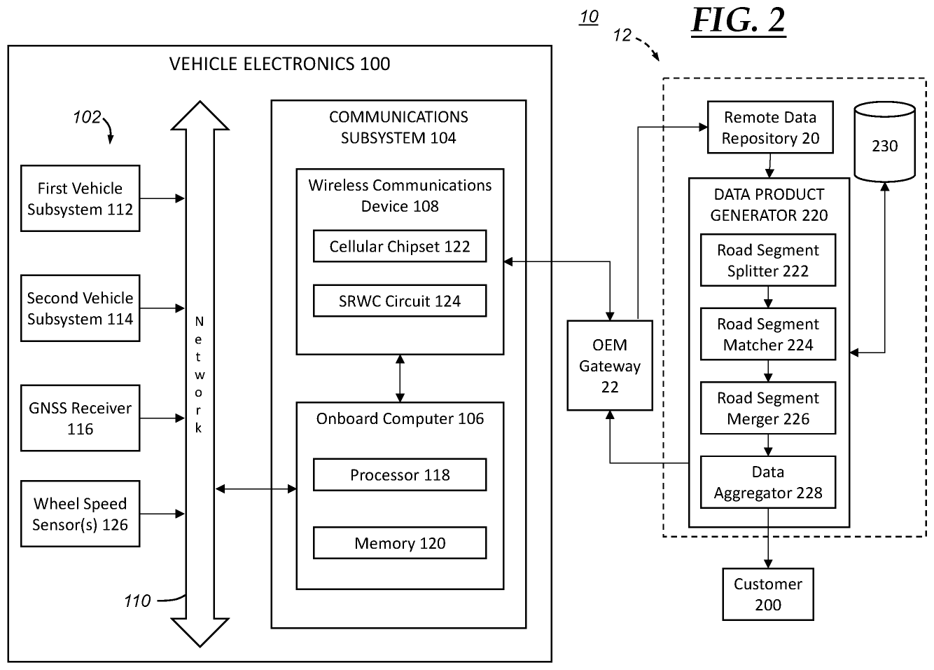

In some embodiments, the OEM may provide the data product system 12 with direct access to the vehicles; for example, by enabling direct streaming of data, such as geographical locations, from the vehicles 14 to the data product system 12, rather than via the OEM gateway 22 (and/or optional OEM data lake 21). This may be done by providing the data product system 12 the necessary credentials and access to the vehicles' communications system 104 (FIG. 2), and techniques for doing that will be known to those skilled in the art.

The OEM gateway 22 is a computer system that operates as an interface between the vehicles 14 and the data product system 12. The OEM gateway 22 may be operated, managed, owned, and/or controlled (collectively “managed”) by an OEM. The OEM gateway 22 may be implemented as computer instructions that are executed by one or more computers or computing devices. In one embodiment, the OEM gateway 22 is configured to receive requests from the data product system 12 and to determine whether to grant or forward those requests to one or more of the vehicles 14. The OEM gateway 22 may implement certain rules or logic to determine whether a particular request from the data product system 12 should or should not be granted.

The data product system 12 is a centralized or distributed computer system that is used to generate one or more data products based on vehicle data, where the vehicle data is provided as a data stream from each of the vehicles 14. In at least some embodiments, the data product system 12 is operated, managed, owned, and/or controlled by a data product party, which is a party that is separate from the OEM that manages the OEM gateway 22. The data product system 12 is shown as including the remote data repository 20 as well as a computing device 34 having an electronic processor 36 and computer-readable memory 38. As used herein an “electronic processor” is a physical processing device that operates under electrical power to execute computer instructions. These computer instructions are stored on the computer-readable memory 38 which is accessible by the electronic processor 36 so that the electronic processor 36 may execute the computer instructions. Although the data product system 12 is illustrated as including a single computing device 34, it should be appreciated that, in other embodiments, the data product system 12 includes a plurality of computing devices 34, each of which has an electronic processor that is configured to access a computer-readable memory, which may or may not be considered part of the computing device. Moreover, in at least some embodiments, the data product system 12 may be provisioned across numerous instances and the functionality described herein as being carried out by the data product system 12 may be carried out in a distributed fashion, such as by one or more computing devices that may or may not be co-located with one another. And, according to some embodiments, the computing device 34 of the data product system 12 may be located remotely from the remote data repository 20 or, in other embodiments, may be co-located with the remote data repository 20. Additionally, it should be appreciated that the computer instructions of the data product system 12 may be stored on one or more memories and/or executed by one or more electronic processors, even though FIG. 1 depicts a single electronic processor and memory.

The plurality of vehicles 14 is illustrated as including at least the first vehicle 16 and the second vehicle 18, each of which is depicted in the illustrated embodiment as a passenger car, but it should be appreciated that any other vehicle including motorcycles, trucks, sports utility vehicles (SUVs), recreational vehicles (RVs), other vehicles or mobility devices that can be used on a roadway or sidewalk, boats, other marine vessels, planes, unmanned aerial vehicles (UAVs), other aerial vehicles, etc., can also be used. Although FIG. 1 only depicts two vehicles 16, 18, it should be appreciated that the vehicles 14 may include any number of vehicles. In some embodiments, the data product system 12 is used to generate data products having data aggregated from information concerning a large number of vehicles and, in such embodiments, the communications system 10 may include a multitude of vehicles, which, as used herein, means at least one thousand (1,000) vehicles.

With reference to FIG. 2, there are shown detailed portions of the communications system 10, including vehicle electronics 100 that may be used as a part of the vehicles 14. The vehicle electronics 100 are electronics that include one or more subsystems and/or components that are installed on a vehicle, such as the first vehicle 16 and the second vehicle 18. Although FIG. 2 depicts certain components and subsystems as being a part of the vehicle electronics 100, it should be appreciated that the vehicle electronics 100 may include various other components and/or subsystems in addition to or in lieu of those components and subsystems specifically shown in FIG. 2.

The vehicle electronics 100 includes a plurality of vehicle subsystems 102, a communications subsystem 104 having an onboard computer 106 and a wireless communications device 108, a communications network 110, a global navigation satellite system (GNSS) receiver 116, and one or more wheel speed sensors 126. The plurality of vehicle subsystems 102 is shown as including a first vehicle subsystem 112 and a second vehicle subsystem 114; however, it should be appreciated that, in other embodiments, the plurality of vehicle subsystems 102 may include any suitable number of vehicle subsystems. In one embodiment, the first vehicle subsystem 112 may be an engine controller and the second vehicle subsystem 114 may be a body computer. Of course, any vehicle subsystem that provides data over the vehicle's bus (e.g., over communications network 110) or that otherwise provides data accessible by the communications subsystem 104 may be used.

The communications subsystem 104 includes the wireless communications device 108 and is connected within the vehicle electronics 100 such that the data from the vehicle subsystems 102, the GNSS receiver 116, and the wheel speed sensor(s) 126 is accessible by the communications subsystem 104. It should be appreciated that, although various processing of the communications subsystem 104 and/or the vehicle electronics 100 is described as being carried out by the onboard computer 106, in one or more embodiments, the processing described herein as being attributed to the onboard computer 106 may be carried out by one or more other computers of the vehicle electronics 100, including those that may or may not be considered as forming a part of the communications subsystem 104. Moreover, although the onboard computer 106 is shown and described as being separate from the wireless communications device 108, in one embodiment, the onboard computer 106 and the wireless communications device 108 are integrated into a single device. Also, although the onboard computer 106 and the wireless communications device 108 are illustrated as being directly coupled to one another, in other embodiments, the onboard computer 106 and the wireless communications device 108 may be coupled to each other via the communications network 110 or other suitable electronic communication connection.

The onboard computer 106 includes an electronic processor 118 and computer-readable memory 120. The memory 120 is operatively coupled to the electronic processor 118 so that the electronic processor 118 may access contents of the memory 120, including in-vehicle computer instructions. The electronic processor 118 is configured to execute the in-vehicle computer instructions, which, in at least one embodiment, cause geographical locations of the vehicle to be streamed to a remote data repository or system so that this information may be accessible by the data product system 12. In at least some embodiments, the in-vehicle computer instructions may operate to provide a geographical location data stream, which is a data stream that includes a succession of geographical locations of the vehicle, and which may include other vehicle data, such as wheel speed data. In some embodiments, in addition to causing the geographical location data stream to be streamed to a remote data repository or system, the in-vehicle computer instructions, when executed, may cause the vehicle electronics 100 to obtain vehicle state information, such as wheel speed data obtained or derived from the one or more wheel speed sensors 126 or other vehicle speed data indicating a current vehicle speed, and to send that information to a remote data repository or system so that data is accessible by the data product system 12. The vehicle state information may be sent separately from the geographical location data stream or, in other embodiments, may be sent as a part of or along with the geographical location data stream.

The wireless communications device 108 is used to provide remote network connectivity to the vehicle electronics 100. The wireless communications device 108 is illustrated as including a cellular chipset 122 and a short range wireless communication (SRWC) circuit 124. However, in other embodiments, the wireless communications device 108 may include only one of the cellular chipset 122 and the SRWC circuit 124. Long-range or remote data communications may be carried out by the wireless communications device 108, such as for purposes of transmitting streaming data to the remote data repository 20. The cellular chipset 122 may be used to provide internet connectivity to the vehicle electronics 100 through establishing communications with the cellular tower 28 of the wireless carrier system 26.

The SRWC circuit 124 enables the vehicle to send and receive wireless messages using one or more SRWC technologies, such as Wi-Fi™, Bluetooth™, IEEE 802.11p, other vehicle to infrastructure (V2I) communications, vehicle to vehicle (V2V) communications, other vehicle to everything (V2X) communications, etc. In one embodiment, the SRWC circuit 124 may be used to connect to a wireless access point hosted by another device, such as a wireless communication device included as a part of roadside equipment or a wireless router and/or modem located at a vehicle user's residence, which may then provide internet or remote network connectivity. For example, the SRWC circuit 124 may transmit data from the vehicle to the remote data repository 20 and/or the OEM gateway 22 via a Wi-Fi™ connection between the wireless communications device 108 and a wireless router/modem, which is then connected to the internet, such as by way of land network 24.

The communications network 110 is an in-vehicle communications network that communicatively couples two or more components or subsystems of the vehicle electronics 100 to each other so that the two or more components may communicate with one another. In the illustrated embodiment of FIG. 2, the communications network 110 is shown as communicatively coupling each of the plurality of subsystems 102, the GNSS receiver 116, and the wheel speed sensor(s) 126 to the communications subsystem 104 and, specifically, the onboard computer 106. In one embodiment, the communications network 110 is implemented as one or more hardwired communication network busses, such as those used for providing a controller area network (CAN), a media oriented system transfer (MOST), a local interconnection network (LIN), a local area network (LAN), and/or other appropriate networks, such as those that use Ethernet or others that conform with known ISO, SAE and IEEE standards and specifications, to name but a few. In one embodiment, the communications network 110 may be implemented as a wireless LAN that uses Wi-Fi™, other IEEE 802.11 technology, or other suitable wireless networking technology.

The global navigation satellite system (GNSS) receiver 116 includes hardware enabling the GNSS receiver 116 to receive GNSS signals transmitted by a constellation of GNSS satellites (not shown). In some embodiments, the GNSS receiver 116 may be a global positioning system (GPS) receiver that receives GPS signals from GPS satellites that are a part of the United States' GPS satellite system. GNSS receivers for use with GLONASS, Europe's Galileo system, or other global positioning system may also be used as the GNSS receiver 116. The GNSS receiver 116 uses the received GNSS signals to obtain GNSS data, which provides a geographical location of the vehicle. In at least some embodiments, the geographical location is specified as a latitudinal and longitudinal coordinate pair. The geographical location may be periodically determined by the GNSS receiver 116 and transmitted over the communications network 110 so that other components of the vehicle electronics 100, such as the onboard computer 106, may obtain the geographical location of the vehicle.

The wheel speed sensor(s) 126 are each a sensor that is coupled to a wheel and that provides a rotational speed of the respective wheel. The rotational speeds from the wheel speed sensor(s) 126 may then be used to obtain a linear vehicle speed, at least in some embodiments. In other embodiments, a linear vehicle speed may be determined based on a succession of geographical locations of the vehicle as determined by the GNSS receiver 116. It should be appreciated that other information, such as other sensor data, may be used along with the rotational wheel speed to determine the linear vehicle speed of the vehicle. The wheel speed sensor(s) 126 can include a tachometer that is coupled to a vehicle wheel and/or other rotating member. In some embodiments, wheel speed sensor(s) 126 can be referred to as vehicle speed sensor(s) (VSS) and can be a part of an anti-lock braking (ABS) system of the vehicle 14 and/or an electronic stability control program. In other embodiments, other sensors or components of the vehicle electronics 100 may be used to determine the linear vehicle speed.

In one embodiment, the onboard computer 106 is configured to obtain certain data communicated over the communications network 110 and, in a particular embodiment, to obtain certain data provided over one or more hardwired communication network busses. In particular, the onboard computer 106 may be configured to obtain a geographical location from the GNSS receiver 116 and then cause this geographical location to be streamed by the wireless communications device 108. According to at least some embodiments, the onboard computer 106 is configured to periodically obtain a geographical location and transmit the geographical location to a remote system or data repository. And, in some embodiments, the onboard computer 106 is configured to periodically obtain vehicle state information, such as a vehicle speed derived from wheel speed sensor data, and transmit the vehicle state information to a remote system or data repository.

As is also shown in FIG. 2, the data product system 12 includes the remote data repository 20, a data product generator 220, and a road segment data store 230. The data product generator 220 includes a road segment splitter 222, a road segment matcher 224, a road segment merger 226, and a data aggregator 228. The data product generator 220 is used to transform data obtained or derived from the remote data repository 20 into one or more data products, which may then be provided to the data product customer 200. As used herein, a “data product” is data derived or otherwise obtained from a collection of data streamed as a part of one or more data streams that are transmitted from a group of vehicles to a remote data repository. In some embodiments, the data product is containerized or packaged data according to a custom or standardized format or protocol. In one embodiment, various processing may be performed on the data of the data streams for purposes of obtaining data to be included as a part of the data product. For example, the data product generator 220 may obtain data stored in the remote data repository 20 and may perform various processing, such as aggregation or analytics, on this obtained data so as to generate processed data that is then packaged into a data product. In other embodiments, the data product generator 220 may receive processed data from another device, module, or system that obtains and processes data stored in the remote data repository 20 and/or received as a part of a data stream. And, in some embodiments, the data product generator 220 may receive processed data and also carry out further processing on this processed data, the result of which may then be included in the data product.

The data product generator 220 is shown as including the road segment splitter 222, which is used to carry out a re-segmentation process. The road segment splitter 222 may be operatively connected to the road segment data store 230, which is a database, data lake, or other data store or repository that includes information or data specifying a plurality of road segments, where each road segment is defined by at least two nodes that are defined by a geographical location, such as a latitudinal/longitudinal coordinate pair. The road segments may correspond to “ways” as used by OpenStreetMap™, and each road segment may include anywhere from 2 to 2000 nodes, at least according to some embodiments. In some embodiments, the road segment data store 230 may be remotely located from the data product system 12 and may be accessed by the data product system 12 via, for example, land network 24. The road segment splitter 222 takes, as input into the re-segmentation process, a plurality of initial road segments (i.e., an initial set of road segments) and then, as a result of the re-segmentation process, outputs a re-segmented set of road segments in which at least one initial road segment (i.e., a road segment from the initial set of road segments) is split into two or more road segments that are then included as a part of the output, which is referred to as the re-segmented set of road segments. In some embodiments, the re-segmented set of road segments may be stored at the road segment data store 230, the remote data repository 20, and/or other database or data store.

The data product generator 220 is shown as including the road segment matcher 224, which is used to match geographical locations to road segments. The geographical locations, which are received from the vehicles 14, are each matched to a road segment, such as a road segment from the re-segmented set of road segments. Vehicle data that is provided along with (or that otherwise corresponds to) the geographical location, such as wheel speed data or linear vehicle speed, may be then associated with the matched road segment. The vehicle data may be data from a vehicle and/or may be data derived from data received from a vehicle. For example, the vehicle data may be linear vehicle speed(s) that is/are obtained based on wheel speed data, linear vehicle speed(s) that is/are derived from a succession of geographical locations of the vehicle, vehicle state data (e.g., vehicle mileage, vehicle ignition status), etc. And, as mentioned above, the vehicle data may be paired or associated with a geographical location, such as by virtue of transmitting this vehicle data along with the geographical location as a part of a vehicle data stream. In this sense, the vehicle data may be data (or derived from data) that was obtained from the vehicle when the vehicle was at the geographical location, at least according to some embodiments. For example, the vehicle data stream may specify a linear vehicle speed and a geographical location, which indicates that the vehicle was travelling at that speed when the vehicle was at that geographical location. In this example, through use of the road segment matcher 224, a road segment may be identified based on the geographical location, and the linear vehicle speed that is paired with the geographical location may then be associated with the identified road segment as a result. In another embodiment, a time at which the vehicle was at the geographical location, which may be determined by the GNSS receiver 116, may be paired with the geographical location and then associated with the identified road segment. In at least some embodiments, a plurality of geographical locations may be associated with a single road segment and the metrics or vehicle data paired/associated therewith may then be aggregated in order to obtain an overall value/metric for the matched road segment.

The road segment matcher 224 may access the road segment data store 230 and/or the output of the road segment splitter 222, which is or at least includes the re-segmented set of road segments. The road segment matcher 224 may use various techniques to identify which road segment is closest to or otherwise corresponds with the geographical location. This may be carried out by identifying the node that is geographically closest to the geographical location and then selecting the road segment having that most-proximate node. In some embodiments, other data, such as vehicle heading, may be used to match the geographical location to a road segment. Various map matching techniques may be used to match the geographical locations to the road segments.

The data product generator 220 is shown as including the road segment merger 226, which is used to carry out a road segment merging process. The road segment merging process is used to merge at least two road segments with one another so as to create a merged road segment that is a concatenation of the at least two road segments. According to at least some embodiments, the road segment merging process takes the re-segmented set of road segments as input and then determines whether to merge certain road segments. Associated vehicle data, which is traffic data in at least some embodiments, is used to determine a correlation of vehicle travel between two adjacent or conjoining road segments. In at least some embodiments, if the correlation value is above a predetermined threshold amount, it is determined to combine the two adjacent/conjoining road segments. In some embodiments, the correlation value is determined through tracking each vehicles' travel and, through use of a cosine similarity technique, the correlation of vehicle travel for each pair of adjacent/conjoining road segments is determined. As a result, at least in some embodiments, the correlation value may be between 0 and 1, where higher values indicate a higher correlation of vehicle travel—i.e., there is a high correlation between vehicle traveling on a first road segment and traveling on a second, conjoining road segment.

The data product generator 220 is shown as including the data aggregator 228, which is used to aggregate or calculate aggregate/overall values for at least some of the road segments of the merged segment set of road segments that is output from the road segment merger 226. As discussed above, the road segment merger 226 is used to merge road segments so as to create merged road segments. And, as discussed above, the road segments of the re-segmented set of road segments have associated traffic data and/or other vehicle data associated therewith. However, because this data was associated with road segments of the re-segmented set of road segments, certain data that is associated with re-segmented road segments that were merged by the road segment merger 226 should be aggregated or otherwise combined so as to be representative of the merged road segment and not the individual (or re-segmented) road segments before merging. Depending on the type of data/value, the aggregating or combining may be carried out in a variety of ways, such as through averaging values (e.g., when the data being aggregated/combined is linear vehicle speed, for example), selecting a representative value (e.g., when the data being aggregated is discrete, such as in the case of a vehicle ignition status, for example), etc. Moreover, in at least some embodiments, specified requirements of the data product to be generated may dictate how the aggregating/combining is carried out.

The road segment data store 230 may also include various other information that may or may not be used as a part of the methods described below. In one embodiment, including in the illustrated embodiment, the road segment data store 230 is included as a part of the data product system 12 and, in some embodiments, may be co-located with the data product generator 220. In one embodiment, the road segment data store 230 is separate and distinct from the remote data repository 20; however, in other embodiments, the road segment data store 230 may be included as a part of the remote data repository 20. In other embodiments, the road segment data store 230 is managed or operated by a different party, such as an OEM or OpenStreetMap™.

The data product customer 200 may provide data product requirements that are to be used to specify attributes of a requested data product. The customer 200 may provide data product request data, which is data indicating which data is to be (or requested to be) included in a data product that is requested by the data product customer 200. The data product request data may be provided to the data product generator 220 directly from the data product customer 200, such as through an application programming interface (API), or may be provided from the data product customer 200 to the data product party or party managing the data product system 12. In the latter case, a person may input the data product request data into the data product system 12 such that it is accessible by the data product generator 220.

Each of the road segment splitter 222, the road segment matcher 224, the road segment merger 226, the data aggregator 228, and other portions of the data product generator 220 may be implemented as executable computer instructions that, when executed by one or more electronic processors of the data product system 12 (e.g., the electronic processor 36 of the computing device 34), cause the data product system 12 to carry out the functionality described herein as being attributed to the road segment splitter 222, the road segment matcher 224, the road segment merger 226, the data aggregator 228, and the other portions of the data product generator 220, respectively. Specifically, for example, the data product system 12 may include road segment splitter computer instructions that, when executed, cause the functionality attributed to the road segment splitter 222 to be carried out.

Any one or more of the electronic processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

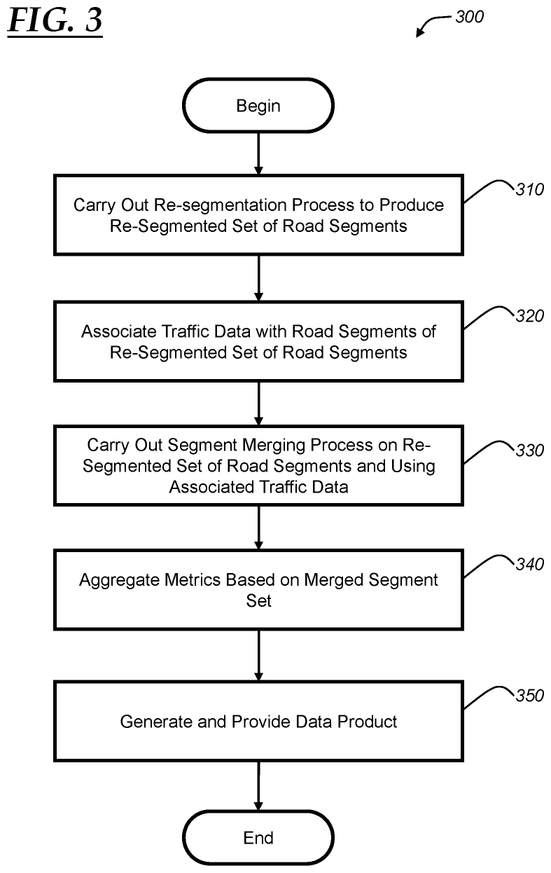

With reference to FIG. 3, there is shown an embodiment of a method 300 of generating and providing a data product using data supplied by a multitude of vehicles. According to at least some embodiments, the method 300 is carried out by the data product system 12 and, in particular, the data product system 12 includes one or more electronic processors (including the electronic processor 36) that are configured to execute data product computer instructions that, when executed by the one or more electronic processors, cause the data product system 12 to carry out the method 300.

The method 300 begins with step 310, wherein a re-segmentation process is carried out. The re-segmentation process includes processing an initial set of road segments (as input) and producing a re-segmented set of road segments (as output). The initial set of road segments may be those that are defined by a third party, such as OpenStreetMap™. In such an example, the initial set of road segments may correspond to a set of “ways” as defined by OpenStreetMap™. The re-segmentation process includes splitting at least one initial road segment (i.e., a road segment from the initial set of road segments) into two or more road segments that are then included as a part of the output, or the re-segmented set of road segments. In at least some embodiments, this step 310 is carried out by the road segment splitter 222 of the data product generator 220.

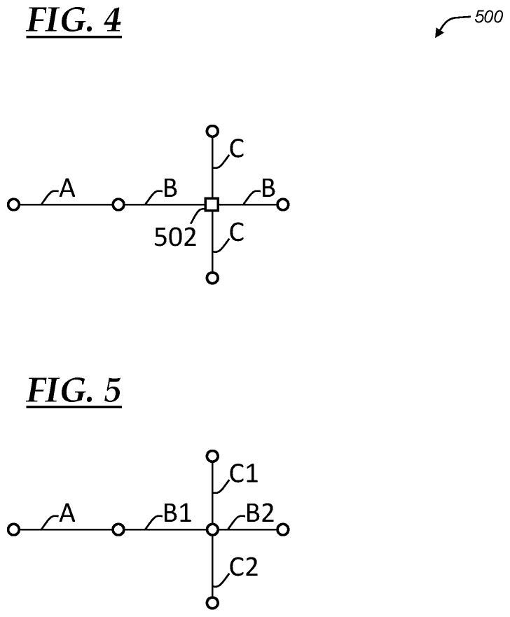

In at least some embodiments, a determination to split an initial road segment (i.e., a road segment of the initial set of road segments) into two re-segmented road segments (i.e., road segments that are included as a part of the re-segmented set of road segments) is based on whether the initial road segment intersects another initial road segment. This determination may be carried out by determining whether the initial road segment shares a node that is not an end node with another initial road segment. For example, as shown in FIG. 4, initial road segment B intersects initial road segment C and these initial road segments B,C share a node 502 that is not an end node. As shown in FIGS. 4-5, the end nodes are identified as circles. Thus, because the initial road segment B shares the node 502 with the initial road segment C, it is determined to split the initial road segment B into two road segments B1,B2. These two road segments B1,B2, which may be referred to as re-segmented road segments, may each include the node 502 as an end node, as shown in FIG. 5. Likewise, the initial road segment C may be split into two re-segmented road segments C1,C2 that share the end node 502, as is also shown in FIG. 5. Of course, other techniques for splitting the initial road segments may be used. Road segment A does not intersect with another road segment and so it is not split, but still included in the re-segmented set of road segments and considered a re-segmented road segment since it was processed by the re-segmentation process. The method 300 continues to step 320.

In step 320, traffic data is attributed to at least a subset of the re-segmented set of road segments. For each road segment of the subset, a portion of the traffic data is attributed to the road segment based on a geographical proximity of the road segment to the portion of traffic data. For example, the data product system 12 may receive geographical location data from the vehicles 14 and this geographical location data may be used to derive or otherwise obtain traffic data, which may be represented as average linear vehicle speed(s), for example. Through use of the road segment matcher 224, the geographical locations of the vehicles 14, which may be received at the data product system 12 as a part of a plurality of vehicle data streams, may be matched to a re-segmented road segment. Then, at least according to some embodiments, the traffic data may be determined, such as through averaging linear vehicle speeds (or through processing other vehicle-related data) of the vehicles 14 as they traveled over the matched re-segmented road segment. The method 300 continues to step 330.

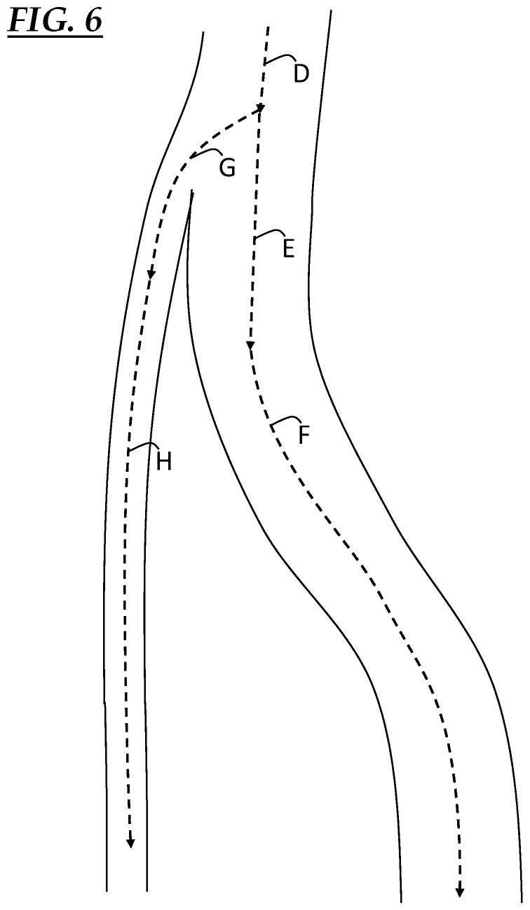

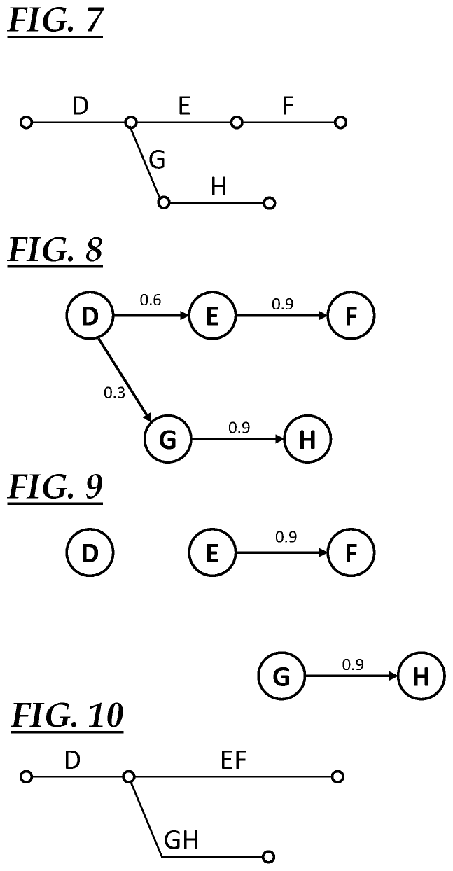

In step 330, a road segment merging process is carried out on the re-segmented set of road segments. The road segment merging process is used to reduce the number of road segments in a way that does not result in a loss (or substantial loss) of precision of the associated traffic data or other associated vehicle data, at least according to some embodiments. With reference to FIGS. 7-10, there is shown an example of certain steps of the road segment merging process that may be used to process road segments D-H, as shown in FIG. 6. FIG. 7 represents a graphic illustrating the five road segments D, E, F, G, H of FIG. 6. The road segments D-H are each defined (at least in part) by two end nodes, as represented in FIG. 7 as circles. Then, values representing correlations of vehicle travel between conjoining road segments (or “correlation values”) are calculated based on the traffic data associated with those road segments. The conjoining relationships and their corresponding correlation values are illustrated in FIG. 8 as a directed graph. Each large circle in FIG. 8 represents one of the road segments from FIG. 7 and each of these circles is connected to one or more other road segments by an edge that has a direction and a value. The direction indicates the direction of travel between the road segments—for example, a vehicle proceeding on road segment D would then encounter road segment E as shown in FIG. 8 by the arrow extending from road segment D to road segment E. The value associated with each of the edges in FIG. 8 represents the correlation value that is determined based on the traffic data. For example, the correlation value for travel between road segment D and road segment E is 0.6 and the correlation value for travel between road segment D and road segment G is 0.3.

In one embodiment, the correlation of travel may be determined by a cosine similarity technique that produces a correlation value between 0 and 1, for example. In some embodiments, the correlation of travel is determined based on traffic metrics, which may include counts of vehicles, speed of flow (or vehicle travel), and/or number of hard braking events. These traffic metrics may be derived from the traffic data and/or from other data of the vehicle data streams that are transmitted from the vehicles 14. Of course, in other embodiments, other traffic metrics or data may be used in addition to or in lieu of the previous examples. In one embodiment, the road segment merging process may be carried out once a day; however, in other embodiments, this process may be carried out according to another frequency, such as twice a day or once every week. In some embodiments, traffic metric values for a given time period, such as for every 15 minutes, may be calculated or otherwise determined. For example, where the road segment merging process is carried out once a day and the time period is 15 minutes, 96 entries are determined for each road segment such that each entry specifies traffic metrics, which may be represented as an aggregate or overall value, for each road segment and time frame of 15 minutes. In one embodiment, cosine similarity may be used to compare two sets of data (e.g., a first set of 96 values (for a first re-segmented road segment) to a second set of 96 values (for a second re-segmented road segment)), and this is done by treating each set of data as coordinates into N-dimensional space—in this example, N=96. The coordinates represent a vector in that space and the cosine similarity technique measures the angle between the vectors and expresses it as a number that scales between −1 and 1, where 1 means the vectors are parallel and −1 means they are exactly opposing. In some embodiments, for the cosine similarity comparison to work properly, all the input data (or traffic metrics, such as vehicle counts) are normalized to a range of 0 to 1 beforehand. This application of the cosine similarity technique yields a correlation value for a pair of adjacent road segments. In other embodiments, other correlation or similarity techniques may be used instead of cosine similarity, such as dynamic time warping.

After generating the directed graph (an example of which is shown in FIG. 8), then each edge may be processed to determine whether it should be removed or kept. This may include determining whether the correlation value is above a predetermined threshold. For example, the predetermined threshold may be 0.7 and, accordingly, all edges that have a correlation value less than or equal to 0.7 are removed. In some embodiments, when there are two outbound road segments that extend from a common road segment and each of these outbound road segments have a correlation value over the predetermined threshold, then the outbound road segment with the highest correlation value is selected and all other edges to other outbound road segments are removed. This removes the possibility of having multiple outbound road segments connected to a given road segment so that the set of road segments to be merged does not include any branching road segments. The resulting directed graph, which (in the present example) is shown in FIG. 9, may then be used to identify which road segments are to be merged. The road segments that remain connected as a subgraph, such as road segments E and F, may then be merged. In some embodiments, once the subgraphs are formed (see FIG. 9, which has three subgraphs), then the subgraphs may be identified and labelled uniquely and, in one embodiment, this is performed using a connected components algorithm. In the present example, this results in merging road segments E and F into a single, merged road segment EF and merging road segments G and H into a single, merged road segment GH. The road segments D, EF, and GH are shown in FIG. 10. Thus, in this example, road segments D, EF, and GH make up the merged set of road segments. The merging may be carried out by identifying a road segment that does not have a connected inbound adjacency (e.g., road segment E in FIG. 9), and then traversing or walking the subgraph and concatenating the other road segments as they are encountered. The merged road segments may then be defined based on this concatenation in combination with the geographical information specified by the underlying road segments, which may be represented as a sequence of nodes each having a geographical coordinate location. For example, for the resulting merged road segment EF, the start location would be the same as the start location for the re-segmented road segment E and the end location would be the same as the end location for the re-segmented road segment F. The method 300 continues to step 340.

In step 340, metrics associated with the merged set or road segments are aggregated or combined in order to obtain aggregated road segment data. In one embodiment, there are metrics or values associated with each road segment of the re-segmented set of road segments, such as the traffic data discussed in step 320. Then, based on which road segments of the re-segmented set of road segments were merged, aggregated or overall values may be determined based on, for example, the traffic data of step 320. For example, an average linear vehicle speed having a value of 40 miles per hour may be determined for re-segmented road segment E and an average linear vehicle speed having a value of 30 miles per hour may be determined for re-segmented road segment F. Then, since, as a result of the road segment merging process, road segments E and F were merged, an average linear vehicle speed for the merged road segment EF may be calculated as (40+30)/2=35 miles per hour. In other embodiments, a weighted average that takes into consideration the length of the underlying road segments may be used. For example, if road segment E is 100 meters in length and road segment F is 200 meters in length, then the aggregate or overall value for merged road segment EF may be calculated as (40*(100/(100+200)))+(30*(200/(100+200)))=33.33 miles per hour. Various other methods or techniques may be used for aggregating metrics. The method 300 continues to step 350.

In step 350, a data product is generated using the aggregated road segment data and provided to a third party. In some embodiments, such as where the data product is a real-time data product, the aggregated road segment data may be continuously updated as vehicle data from various vehicle data streams are received at the data product system 12. In this sense, the real-time data product is a streaming data product that is continuously updated in response to receiving geographical locations and/or other vehicle-related data from the vehicles 14. Once or as the data product is assembled or otherwise generated, the data product may be provided to the data product customer 200, such as through electronically transmitting the data product to a computing device used by the data product customer 200 or by making the data product available to the data product customer 200, such as by sending a download or access URL to the data product customer 200 that enables the data product customer 200 to download or otherwise access the data product. In one embodiment, the data product system 12 transmits the data products to the third party computer system or, in another embodiment, the data product system 12 provides a download or access link to the third party or third party computer system that is usable to access and/or download the data product. The method 300 then ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A data product system for generating and providing a data product using data supplied by a multitude of vehicles, wherein the data product system comprises one or more electronic processors and memory storing computer instructions accessible by the one or more electronic processors of the data product system;
wherein the data product system is configured so that, when the computer instructions are executed by the one or more electronic processors of the data product system, the data product system:
carries out a re-segmentation process in which an initial set of road segments are processed so as to obtain a re-segmented set of road segments, wherein the re-segmented set of road segments includes a first re-segmented road segment and a second re-segmented road segment, and wherein the first re-segmented road segment and the second re-segmented road segment are obtained by splitting a road segment of the initial set of road segments;
attributes traffic data to at least a subset of the re-segmented set of road segments, wherein, for each road segment of the subset of re-segmented road segments, a portion of the traffic data is attributed to the road segment based on a geographical proximity of the road segment to the portion of traffic data;
carries out a road segment merging process on the re-segmented set of road segments in order to obtain a merged set of road segments;
aggregates metrics associated with the merged set of road segments to obtain aggregated road segment data;
generates the data product using the aggregated road segment data; and
provides the data product to a third party.

2. The data product system of claim 1, wherein the merged set of road segments includes a merged road segment, and wherein the merged road segment is a concatenation of the first re-segmented road segment and a third re-segmented road segment of the re-segmented set of road segments.

3. The data product system of claim 1, wherein the road segment merging process includes determining whether to merge two re-segmented road segments of the re-segmented set of road segments based on a correlation of vehicle travel between the two re-segmented road segments.

4. The data product system of claim 3, wherein the correlation of vehicle travel is determined using a cosine similarity technique.

5. The data product system of claim 3, wherein, as a part of the road segment merging process, it is determined to merge the two re-segmented road segments when the correlation of vehicle travel is above a predetermined threshold amount.

6. The data product system of claim 5, wherein the re-segmentation process includes identifying a shared node, wherein the shared node is a part of a first initial road segment of the initial set of road segments and a second initial road segment of the initial set of road segments, and wherein the shared node is not an end node of the first initial road segment or the second initial road segment.

7. The data product system of claim 1, wherein the initial set of road segments are obtained from a third party system.

8. The data product system of claim 7, wherein the third party system is OpenStreetMap™.

9. The data product system of claim 1, wherein the traffic data is or is based on geographical location data streams from at least a subset of the multitude of vehicles.

10. The data product system of claim 9, wherein the metrics associated with the merged set of road segments includes traffic-related metrics, and wherein the traffic-related metrics are based on the attributed traffic data.

11. The data product system of claim 10, wherein the traffic-related metrics include an amount or indication of traffic congestion for a given road segment of the merged set of road segments.

12. The data product system of claim 1, wherein the aggregated road segment data includes an average vehicle speed for a given road segment of the merged set of road segments.

13. A method of generating and providing a data product using data supplied by a multitude of vehicles, wherein the method is carried out by a data product system comprising one or more electronic processors, and wherein the method comprises the steps of:
carrying out a re-segmentation process in which an initial set of road segments are processed so as to obtain a re-segmented set of road segments, wherein the re-segmented set of road segments includes a first re-segmented road segment and a second re-segmented road segment, and wherein the first re-segmented road segment and the second re-segmented road segment are obtained by splitting a road segment of the initial set of road segments;
attributing traffic data to at least a subset of the re-segmented set of road segments, wherein, for each road segment of the subset of re-segmented road segments, a portion of the traffic data is attributed to the road segment based on a geographical proximity of the road segment to the portion of traffic data;
carrying out a road segment merging process on the re-segmented set of road segments in order to obtain a merged set of road segments;
aggregating metrics associated with the merged set of road segments to obtain aggregated road segment data;
generating the data product using the aggregated road segment data; and
providing the data product to a third party.

14. The method of claim 13, wherein the merged set of road segments includes a merged road segment, and wherein the merged road segment is a concatenation of the first re-segmented road segment and a third re-segmented road segment of the re-segmented set of road segments.

15. The method of claim 13, wherein the road segment merging process includes determining whether to merge two re-segmented road segments of the re-segmented set of road segments based on a correlation of vehicle travel between the two re-segmented road segments.

16. The method of claim 16, wherein the correlation of vehicle travel is determined using a cosine similarity technique.

17. The method of claim 16, wherein, as a part of the road segment merging process, it is determined to merge the two re-segmented road segments when the correlation of vehicle travel is above a predetermined threshold amount.

18. The method of claim 17, wherein the re-segmentation process includes identifying a shared node, wherein the shared node is a part of a first initial road segment of the initial set of road segments and a second initial road segment of the initial set of road segments, and wherein the shared node is not an end node of the first initial road segment or the second initial road segment.

19. The method of claim 13, wherein the initial set of road segments are obtained from OpenStreetMap™.

20. The method of claim 13, wherein the traffic data is or is based on geographical location data streams from at least a subset of the multitude of vehicles.
